(19) United States
(12) Patent Application Publication
(10) Pub. No.: US 2011/0127433 A1
(43) Pub. Date: Jun. 2, 2011

(54) DEVICE AND METHOD FOR DETERMINING MOISTURE IN A SAMPLE

(76) Inventors: Hartmut Spennemann, Aschaffenburg (DE); Ingo Ramsteiner, Leonberg (DE); Michael Thiel, Leonberg (DE); Sascha Steinkogler, Freiburg (DE); Ulrich Ladstaetter, Weinstadt (DE)

(21) Appl. No.: 12/938,869

(22) Filed: Nov. 3, 2010

(30) Foreign Application Priority Data
Nov. 4, 2009 (DE) 102009046390.9

(51) Int. Cl. G01J 5/02; G01J 5/00

(52) U.S. Cl. 250/341.8; 250/338.1

(57) ABSTRACT

A device has a radiation device for radiating a terahertz signal onto the sample, a receiving device for receiving the terahertz signal reflected at the sample, a measuring device for measuring the intensity of the terahertz signal received and an analytical device for determining the moisture in the sample as a function of the measured intensity of the terahertz signal received.

### CROSS-REFERENCE TO RELATED APPLICATIONS

The present application claims priority to Application No. 10 2009 046 390.9, filed in the Federal Republic of Germany on Nov. 4, 2009, which is expressly incorporated herein in its entirety by reference thereto.

### FIELD OF THE INVENTION

The present invention relates to a device and a method for determining moisture in a sample, particularly the direct measurement of the moisture or of the moisture content of skin samples and mucous membrane samples.

### BACKGROUND INFORMATION

Conventional devices for determining moisture, such as moisture sensors, impedance measuring devices or capacitance measuring devices determine the electrical resistance of the skin or the mucous membrane. This is usually carried out by a direct current measurement. In addition, this measurement may also be carried out over a certain frequency range. The measured resistance does change as a function of the water content of the sample, but salts and other trace elements are able to change the electrical resistance of the skin or the mucous membrane, since pure water has no electrical resistance.

### SUMMARY

The device according to example embodiments of the present invention, having the features described herein, and the method according to example embodiments of the present invention, having the features described herein, each have the advantage that the moisture in the sample is able to be determined more accurately than by conventional impedance measurement devices or capacitance measurement devices. Furthermore, the moisture in the sample, and thus the water content in the sample, is ascertained independently of trace elements, salts and the like in the sample. The device according to example embodiments of the present invention may be used for determining the type of the sample, especially the skin type, for the current monitoring the balance of water in the body, especially for measuring mucous membrane moisture and for long-term monitoring of the water content of the skin via the moisture development. The device according to example embodiments of the present invention, for example, permits the care-giving personnel to detect dehydration more rapidly by measuring the moisture of mucous membranes, and with that, especially to be able to monitor progress of a therapy for improving the water content in the body. This makes the use of the device according to example embodiments of the present invention particularly suitable in assisted living, where there is no rapid access to laboratory technology present.

According to example embodiments of the present invention, the moisture or the water content of the sample, that is, of the skin or the mucous membrane sample, is able to be determined directly, and with that, without the presence of foreign substances, such as salts, trace elements or fat.

The moisture in the sample is recorded using a reflection measurement, by the radiation device, particularly a narrow band THz emitter in the frequency range between 0.5 to 2 THz By evaluating the amount and possibly the phase of the reflected terahertz signal, the moisture in the sample is able to be ascertained directly. In the terahertz range, in the skin, changes in the index of refraction and of the absorption behavior are able to be analyzed by such a reflection measurement. The optical resolution and the penetration depth are determined by the frequency used. Low frequencies of about 0.2 THz have a resolution of about 2.5 mm. Higher frequencies, of 2 THz, for example, may resolve finer ranges, but they have a low penetration depth and are clearly more costly to produce. For this reason, according to example embodiments of the present invention, frequencies of 0.2 to 0.5 THz are used, which are able to be produced cost-effectively, using InP, GaAs or even SiGe HF processes.

Accordingly, a device is provided for the moisture determination of a sample, for instance, a skin sample or a sample of a mucous membrane, which has: a radiation device for radiating a terahertz signal onto the sample, a receiving device for receiving the terahertz signal reflected at the sample, a measuring device for measuring the intensity of the terahertz signal received, and an analytical device for determining the moisture in the sample as a function of the measured intensity of the terahertz signal received.

Moreover, a method is provided for the moisture determination of a sample, for instance, a skin sample or a sample of a mucous membrane, which includes: radiating a terahertz signal onto the sample, receiving the terahertz signal reflected at the sample, measuring the intensity of the terahertz signal received, and determining the moisture in the sample as a function of the measured intensity of the terahertz signal received.

Furthermore, a chip or a computer program product is provided which induces the carrying out of at least a part of a method as described above, on a program-controlled device.

A computer program product may be made available or supplied, for example, as a memory medium, a memory card, a USB stick, a floppy disk, a CD-ROM, a DVD or even in the form of a data file of a server in a network that is able to be down-loaded.

A terahertz signal (THz signal) includes a signal having a frequency of at least 0.1 THz (100 GHz or 1×10¹¹ Hz).

The radiation device may radiate, onto the sample, the terahertz signal at an adjustable frequency above a lower frequency limit.

The lower frequency limit is 0.2 THz, in particular.

According to example embodiments, the radiation device has: an oscillator device for generating a sinusoidal oscillation signal having a frequency of 50 GHz, for example, a frequency multiplication device for providing the terahertz signal by multiplying the sinusoidal oscillation signal (for instance, the quadrupling at 50 GHZ base frequency), and a patch antenna for radiating the terahertz signal onto the sample.

The oscillator device is arranged as a 50 GHz oscillator in silicon-germanium technology, for instance. Such an oscillator device is described, for instance, in “A 52 GHz VCO with Low Phase Noise Implemented in SiGe BiCMOS Technology, Calgary, Alberta, Canada, June 30-July 2, The 3rd IEEE International Workshop”.

The frequency multiplier device or the frequency multiplier multiplies the sinusoidal oscillation signal provided by a predetermined multiplication factor. The multiplication factor may be 4, 6 or 8, for example. Such a frequency multiplier may also be arranged as a discrete multiplier.

According to example embodiments, the receiving device has a patch antenna for receiving the terahertz signal reflected at the sample. A patch antenna is particularly suitable for receiving terahertz signals.

According to example embodiments, the measuring device has a diode prepared to receive terahertz signals for providing a direct current as a function of the terahertz signal received, and a rectifier device for providing a direct voltage as a function of the direct current provided.

According to example embodiments, the analytical device has an A/D converter for making available a digital output signal as a function of the direct voltage provided.

According to example embodiments, the device is integrated on a single chip. The device is thus arranged as an IC (integrated circuit).

Because of the arrangement of the device on one chip or an IC, only short electric lines are required, so that higher efficiency and greater reliability are able to be provided in a cost-effective manner.

According to example embodiments, the measuring device is prepared for measuring the intensity or the amount of the terahertz signal received, and for determining the phase of the terahertz signal received.

According to example embodiments, the analytical device determines the moisture of the sample as a function of the measured intensity and the determined phase of the terahertz signal received.

A potential determination error or analytical error is minimized by using two independent parameters, amount and phase. The determination error is defined, in this context, as the difference between the determined moisture and the actual moisture of the sample.

In particular, all values measured for amount and phase at the output side are averaged. Subsequently, all individual values, separated according to amount and phase, are normalized. The values thus normalized for amount and phase are transformed to a scalable value by a suitable transformation. The coefficients of the transformation are derived particularly from calibration measurements.

According to example embodiments, the device has an oscillator device for generating a sinusoidal oscillation signal having a higher frequency of, for instance, at least 88 GHz and an energy distribution device (power splitter) for the uniform distribution of the sinusoidal oscillation signal generated to a receiving branch and sending branch.

According to example embodiments, the transmitting branch has an amplification device for amplifying the sinusoidal oscillation signal, a frequency multiplier device for providing the terahertz signal by multiplying the amplified sinusoidal oscillation signal, a patch antenna for radiating the terahertz signal and a resonator device for enlarging the bandwidth of the radiated terahertz signal.

According to example embodiments, the receiving branch has a heterodyne receiver. The heterodyne receiver preferably forms the receiving device, the measuring device and the analytical device.

According to example embodiments, the heterodyne receiver has a single-sideband mixer for shifting the frequency of the sinusoidal oscillation signal, an amplification device for amplifying the frequency-shifted sinusoidal oscillation signal, a frequency multiplication device for multiplying the amplified, frequency-shifted sinusoidal oscillation signal and a subharmonic mixer for mixing the amplified, frequency-shifted sinusoidal oscillation signal and the terahertz signal received that was reflected at the sample.

A single-sideband mixer is described, for example, in European Published Patent Application No. 0 329 077, or in “Millimetre-wave s.s.b. mixer with integrated local-oscillator injection, Electronic Letters, Apr. 14, 1977 Vol. 13, Issue 8, Page 226-227”.

According to example embodiments, the sending branch is integrated on a single chip. Alternatively or in addition, the receiving branch is integrated on one chip. In particular, the sending branch and the receiving branch are integrated on one single chip. That being the case, the sending branch and the receiving branch are formed on one IC (integrated circuit).

Because of the arrangement of the device on one chip or an IC, only short electric lines are required, so that higher efficiency and greater reliability are able to be provided in a cost-effective manner.

Further features and aspects of example embodiments of the present invention are described in more detail below with reference to the appended Figures.

### BRIEF DESCRIPTION OF THE DRAWINGS

FIG. 1 is a schematic block diagram of a device according to an example embodiment of the present invention for determining the moisture in a sample.

FIG. 2 is a schematic block diagram of a device according to an example embodiment of the present invention for determining the moisture in a sample.

FIG. 3 is a schematic block diagram of a device according to an example embodiment of the present invention for determining the moisture in a sample.

FIG. 4 is a schematic flow chart of a method according to an example embodiment of the present invention for determining the moisture in a sample.

### DETAILED DESCRIPTION

In the figures, the same reference symbols identify the same components or components having an identical function.

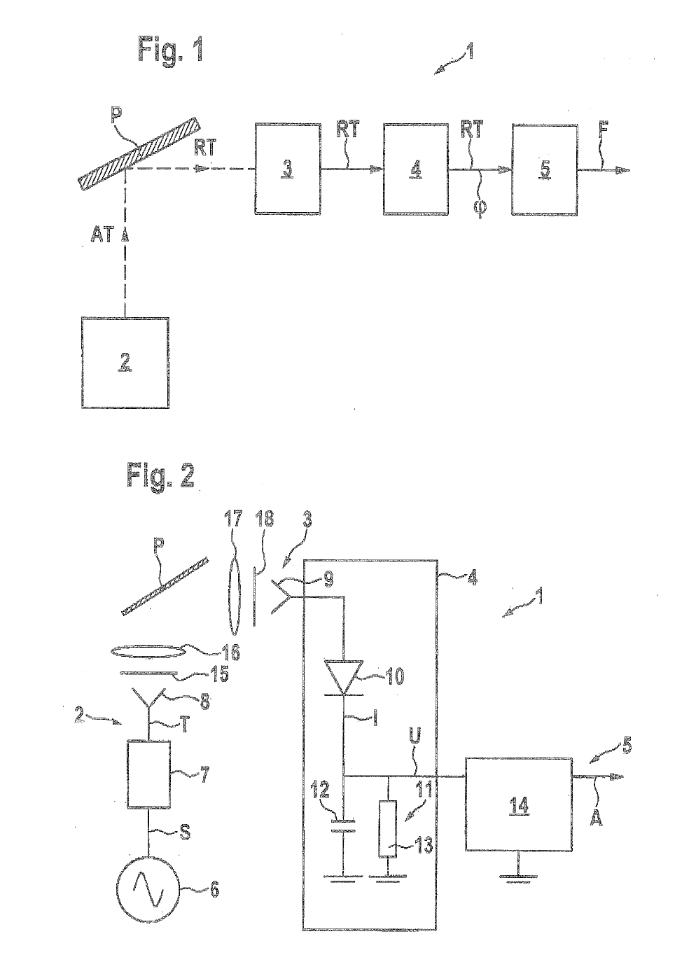

FIG. 1 shows a schematic block diagram of a device 1 according to an example embodiment of the present invention, for determining the moisture in a sample P, for instance a skin sample or a mucous membrane sample.

Device 1 as in FIG. 1 has a radiation device 2, a receiving device 3, a measuring device 4 and an analytical device 5.

Radiation device 2 is equipped to radiate a terahertz signal AT onto sample P. Radiation device 2 sends terahertz signal AT at an adjustable frequency above a lower frequency limit. The lower frequency limit is 0.2 THz, for example.

Receiving device 3 is equipped to receive terahertz signal RT that is reflected at sample P. Measuring device 4 is equipped to measure intensity IN of received terahertz signal RT. Intensity IN includes the amount of reflected and received terahertz signal RT.

Analytical device 5 is equipped to determine moisture F of sample P as a function of measured intensity IN of received terahertz signal RT. Receiving device 3, measuring device 4 and analytical device 5 may be arranged as a zero-bias detector, for example.

Measuring device 4 is preferably equipped for measuring intensity IN of received terahertz signal RT and for determining phase φ of received terahertz signal RT. In such a case, postconnected analytical device 5 is able to be equipped to determine moisture F of sample P as a function of measured intensity IN and determined phase φ of received terahertz signal RT.

Device 1 is particularly integrated on a single chip. For the arrangement of device 1, a silicon-germanium design approach is especially provided.

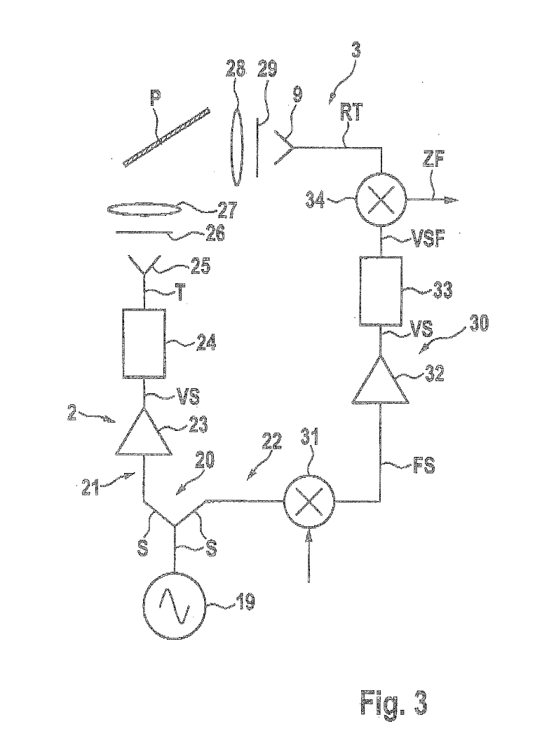

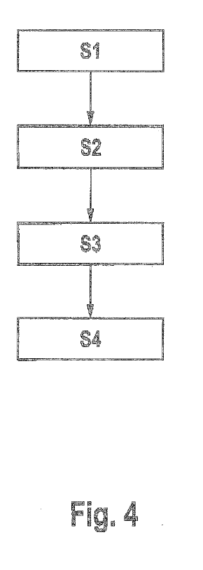

FIGS. 2 and 3 show example embodiments of device 1 according to FIG. 1.

FIG. 2 shows a schematic block diagram of a device 1 for the moisture determination in a sample P, in this context.

According to FIG. 2, radiation device 2 has an oscillator device 6, a frequency multiplier device 7 and a patch antenna 8.

Oscillator device 6 is equipped to generate a sinusoidal oscillation signal S having a frequency of at least 50 GHz, for example.

Frequency multiplier device 7 is postconnected to oscillator device 6. Frequency multiplier device 7 multiplies sinusoidal oscillation signal S provided, so as to provide terahertz signal T at its output side. The multiplication factor of frequency multiplier device 7 is 4, for instance. Then terahertz signal T has a frequency of 200 GHz or 0.2 THz.

Patch antenna 8 is equipped to radiate terahertz signal T onto sample P. Patch antenna 8 may also have a transmission resonator 15 and a transmitting lens 16 appearing downstream from it. Transmission resonator 15 is particularly equipped to amplify the bandwidth of radiated terahertz signal AT.

Correspondingly, a receiving lens 17 and a reception resonator 18 are preconnected to receiving device 3.

Receiving device 3 is especially arranged as a patch antenna 19, for receiving terahertz signal RT reflected at sample P.

Measuring device 4 has a diode 10. Diode 10 is equipped to receive terahertz signal RT. Furthermore, diode 10 makes available, at its output end, a pulsing direct current I of amplitude Ia, as a function of terahertz signal RT received. A low-pass filter 11 is postconnected to diode 10. Low-pass filter 11 is made up of an in-parallel connection of a capacitor 12 and a resistor 13. Low-pass filter 11, together with diode 1, on the output end makes available a direct voltage U, as a function of current I supplied by diode 10.

Analytical device 5 of device 1 in FIG. 2 has an A/D converter 14. A/D converter 14 is equipped to supply a digital output signal A as a function of the direct voltage U provided. Digital output signal A indicates moisture F of sample P.

FIG. 3 shows a device 1 according to an example embodiment of the present invention for determining the moisture in sample P.

According to FIG. 3, device 1 has an oscillator device 19 for generating a sinusoidal oscillation signal S having a frequency of at least 88 GHz, for example. Oscillator device 19 has a power splitter 20 postconnected to it for the uniform distribution of generated sinusoidal oscillation signal S to a sending branch 21 and a receiving branch 22.

Sending branch 21 has an amplifying device 23, a frequency multiplier device 24 that is postconnected to amplifying device 23 and a patch antenna 25 that is postconnected to frequency multiplier device 24.

Amplifying device 23 amplifies sinusoidal oscillation signal S that is provided.

Frequency multiplier device 24 is equipped to make available terahertz signal T by multiplying amplified sinusoidal oscillation signal VS. The multiplication factor of frequency multiplier device 24 is equal to 6, for example. The terahertz signal provided has a frequency of 528 GHz (88 GHz×6=528 GHz).

Patch antenna 25 is equipped to emit terahertz signal T. Patch antenna 25 may also have, appearing downstream from it, a transmission resonator 26 and a transmitting lens 27. Transmission resonator 26 is equipped to amplify the bandwidth of radiated terahertz signal AT.

By analogy to FIG. 2, terahertz signal RT reflected by sample P is guided through a receiving lens 28 and through a reception resonator 29 before reaching device 3.

Receiving branch 22 which, the same as sending branch 21, receives provided sinusoidal oscillation signal S, is arranged as a heterodyne receiver 30, for example.

Heterodyne receiver 30 has a single-sideband mixer 31, an amplifying device 23 postconnected to single-sideband mixer 31, a frequency multiplier device 33 appearing downstream from amplifying device 32 and a subharmonic mixer 34.

Single-sideband mixer 31 is equipped to shift the frequency of sinusoidal oscillation signal S. The frequency of 88 GHz of sinusoidal oscillation signal S is shifted by 400 Hz, for example.

Amplifying device 32 is equipped to amplify the frequency-shifted sinusoidal oscillation signal VS, in order to provide a sufficient signal level.

Frequency multiplier device 33 is equipped to multiply VSF amplified, frequency-shifted sinusoidal oscillation signal VS. The multiplication factor of frequency multiplier device 33 is equal to 3, for example. In particular, the multiplication factor of frequency multiplier device 33 is half as big as the multiplication factor of frequency multiplier device 24 of sending branch 21.

Subharmonic mixer 34 is equipped to mix multiplied signal VSF of receiving branch 22 with reflected, received terahertz signal RT. The mixed frequency is determined from the difference between the receiving frequency and double the frequency of multiplied signal VSF. Conditioned upon the construction, this frequency amounts to n times the shift in frequency (FS-S) (for example: 6*400 Hz=2.4 kHz). The output signal of subharmonic mixer 34 is intermediate frequency ZF. Moisture F of sample P may be derived from the amplitude and the phase of intermediate frequency ZF.

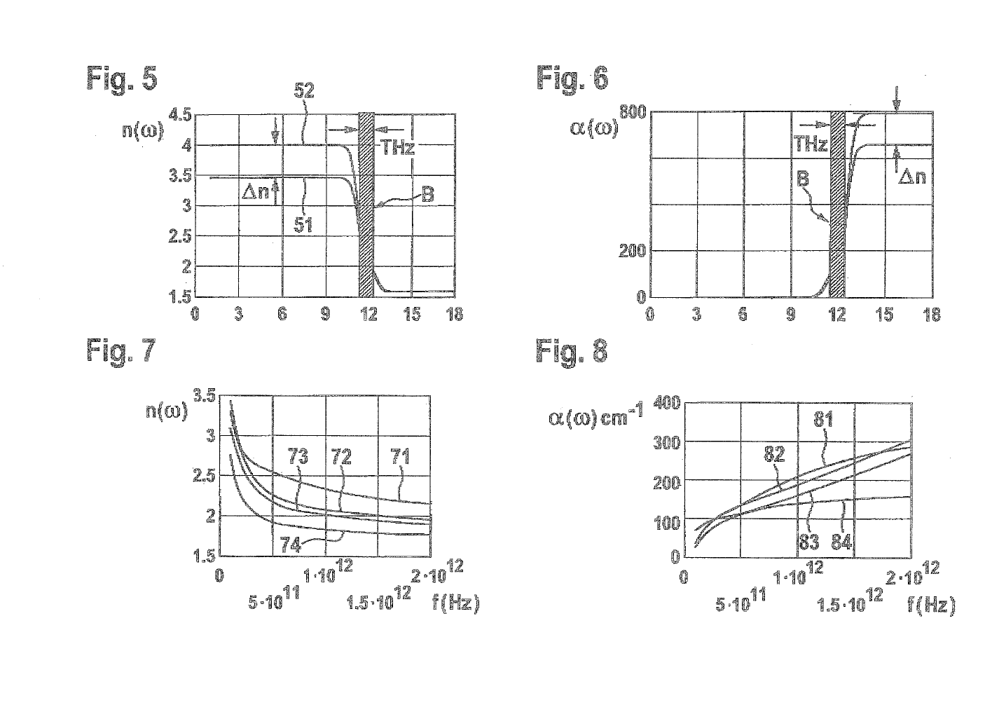

FIG. 4 shows a schematic flow chart of a method, according to an example embodiment of the present invention, for moisture determination in a sample P.

The exemplary embodiment of the method, according to FIG. 4, is described with reference to FIG. 1, and has the following steps S1-S4:

### Method Step S1:

A terahertz signal AT is radiated onto sample P.

### Method Step S2:

Terahertz signal RT reflected at sample P is received.

### Method Step S3:

Intensity IN of the received terahertz signal RT is measured. The measurement of intensity IN includes the measurement of the amount of the received terahertz signal RT and, optionally in addition, the measurement of the phase of the terahertz signal RT received.

### Method Step S4:

Moisture F of sample P is determined as a function of the measured intensity IN of the terahertz signal RT received. Moisture F is particularly determined as a function of the amount and the phase of terahertz signal RT received.

It is possible, for instance, that one might also operate the exemplary embodiment of FIG. 2 at 500 GHz. In this case, the oscillator frequency and the multiplication factor are adjusted; for instance, the oscillator frequency is set to 31.25 GHz and the multiplication factor of the frequency multiplier is set to 16.

What is claimed is:

1. A device for determining moisture of a sample, comprising:
a radiation device adapted to radiate a terahertz signal onto the sample;
a receiver device adapted to receive the terahertz signal reflected at the sample;
a measurement device adapted to measure an intensity of the terahertz signal received; and
an analytical device adapted to determine the moisture of the sample as a function of the measured intensity of the terahertz signal received.

2. The device according to claim 1, wherein the radiation device is adapted to radiate the terahertz signal onto the sample at an adjustable frequency above a lower frequency limit.

3. The device according to claim 1, wherein the radiation device includes:
an oscillator device adapted to generate a sinusoidal oscillation signal having a frequency of at least 50 GHz;
a frequency multiplier device adapted to provide the terahertz signal by multiplying the sinusoidal oscillation signal that is provided; and
a patch antenna adapted to radiate the terahertz signal onto the sample.

4. The device according to claim 3, wherein the receiver device has a patch antenna adapted to receive the terahertz signal reflected at the sample.

5. The device according to claim 3, wherein the measurement device includes a diode, adapted to receive terahertz signals, adapted to make available a direct current as a function of the received terahertz signal and a rectifier device adapted to make available a direct voltage as a function of the direct current supplied.

6. The device according to claim 5, wherein the analytical device includes an A/D converter adapted to make available a digital output signal as a function of the direct voltage supplied

7. The device according to claim 1, wherein the device is integrated on a single chip.

8. The device according to claim 1, wherein the measurement device is adapted to measure the intensity of the received terahertz signal and to determine a phase of the received terahertz signal.

9. The device according to claim 8, wherein the analytical device is adapted to determine the moisture of the sample as a function of the measured intensity and the determined phase of the terahertz signal received.

10. The device according to claim 8, further comprising an oscillator device adapted to generate a sinusoidal oscillation signal at a frequency of at least 88 GHz and a power splitter adapted for uniform distribution of the generated sinusoidal oscillation signal to a sending branch and a receiving branch.

11. The device according to claim 10, wherein the sending branch includes an amplifying device adapted to amplify the sinusoidal oscillation signal, a frequency multiplier device adapted to make available the terahertz signal by multiplying the amplified sinusoidal oscillation signal, a patch antenna adapted to radiate the terahertz signal and a resonator device adapted to amplify a bandwidth of the radiated terahertz signal.

12. The device according to claim 10, wherein the receiving branch includes a heterodyne receiver, which forms the receiving device, the measuring device and the analytical device.

13. The device according to claim 12, wherein the heterodyne receiver includes a single-sideband mixer adapted to shift a frequency of the sinusoidal oscillation signal, an amplification device adapted to amplify the frequency-shifted sinusoidal oscillation signal, a frequency multiplication device adapted to multiply the amplified, frequency-shifted sinusoidal oscillation signal and a subharmonic mixer adapted to mix the amplified, frequency-shifted sinusoidal oscillation signal and the terahertz signal received reflected at the sample.

14. The device according to claim 10, wherein at least one of (a) the sending branch is integrated on one chip and (b) the receiving branch is integrated on one chip.

15. A method for determining moisture of a sample, comprising:
radiating a terahertz signal onto the sample;
receiving the terahertz signal reflected at the sample;
measuring an intensity of the terahertz signal received; and
determining the moisture of the sample as a function of the measured intensity of the terahertz signal received.
